(19) United States
(12) Patent Application Publication
(10) Pub. No.: US 2015/0367894 A1
(43) Pub. Date: Dec. 24, 2015

(54) Three-Wheeled Vehicle

(71) Applicant: Joel O. Ogbonna, Fort Washington, MD (US)

(72) Inventor: Joel O. Ogbonna, Fort Washington, MD (US)

(21) Appl. No.: 14/496,784

(22) Filed: Sep. 25, 2014

Related U.S. Application Data
(60) Provisional application No. 62/014,267, filed on Jun. 19, 2014.

(51) Int. Cl. B62D 31/00; B62D 25/06; B60K 5/00; B62D 61/08; B60N 2/24

(52) U.S. Cl. CPC B62D 31/00; B62D 61/08; B60N 2/242; B60K 5/00; B62D 25/06

(57) ABSTRACT

A three-wheeled vehicle is an open-air vehicle that is utilized for sightseeing and tourism applications as well as for conventional transportation. The open-air design of the three-wheeled vehicle allows for an unadulterated and unimpeded experience for passengers. The three-wheeled vehicle features a vehicle body with a driver compartment and a passenger compartment that are separated from each other via an engine compartment. Overhead cover is provided by an arched roof. A power train includes an engine with throttle that may be controlled by the driver of the three-wheeled vehicle by actuating an acceleration pedal in order to regulate the speed of the three-wheeled vehicle. Torque and speed provided by the engine is output into a transmission and different into a left drive wheel and right drive wheel to propel the three-wheeled vehicle. A steering system allows the driver to control the movement of a front wheel.

The current application claims a priority to the U.S. Provisional Patent application Ser. No. 62/014,267 filed on Jun. 19, 2014.

### FIELD OF THE INVENTION

The present invention relates generally to a three-wheeled vehicle. More specifically, the present invention is a three-wheeled vehicle that is utilized for tourism and sightseeing purposes as well as for general transportation.

### BACKGROUND OF THE INVENTION

When traveling for pleasure, it is common for the traveler to embark on sightseeing tours in order to experience the landmarks and attractions that are local to the travel location. Sightseeing and tourism is often done with the use of a vehicle in order to enhance the experience. For example, a helicopter tour may be appropriate for viewing a location that is sweeping and grandiose from an aerial perspective. The sights of a location near a body of water may be best experienced from the perspective offered by a boat or amphibious vehicle. Finally, a vehicle may be altogether unnecessary for sightseeing as moving on foot may be more convenient and practical for experiencing a location. Regardless of the transportation means or absence of transportation means, one of the most sought-after qualities of sightseeing is an unadulterated and unimpeded experience. This is particularly the case with sightseeing in nature-based locations as well as other locations where external factors may negatively affect the experience, for example, by hindering one's ability to capture a scene in a photograph. As such, if transportation is utilized during sightseeing, it is important that the transportation means only enhances and does not hamper the experience.

The present invention is a three-wheeled vehicle that may be utilized for a variety of sightseeing and tourism-related applications as well as for conventional transportation. The present invention is capable of transporting a driver as well as multiple passengers and features an open-air design that provides passengers with an unobstructed view of the surrounding environment. The open-air design additionally allows passengers to conveniently photograph or video record a scene without being impeded by the potential glare or grime presented by a window. The present invention features passenger seating that facilitates conversation while sightseeing. The passenger seating additionally provides different viewing perspectives and vantage points for the passengers as well.

### BRIEF DESCRIPTION OF THE DRAWINGS

FIG. 1 is a perspective view of the present invention.

FIG. 2 is an alternative perspective view of the present invention.

FIG. 3 is an additional alternative view of the present invention.

FIG. 4 is a cross-sectional view of the present invention.

FIG. 5 is a diagrammatic overview of the braking mechanism of the present invention.

FIG. 6 is a diagrammatic overview of the electrical connections of the present invention.

FIG. 7 is a perspective view of an alternative embodiment of the present invention.

### DETAIL DESCRIPTIONS OF THE INVENTION

All illustrations of the drawings are for the purpose of describing selected versions of the present invention and are not intended to limit the scope of the present invention.

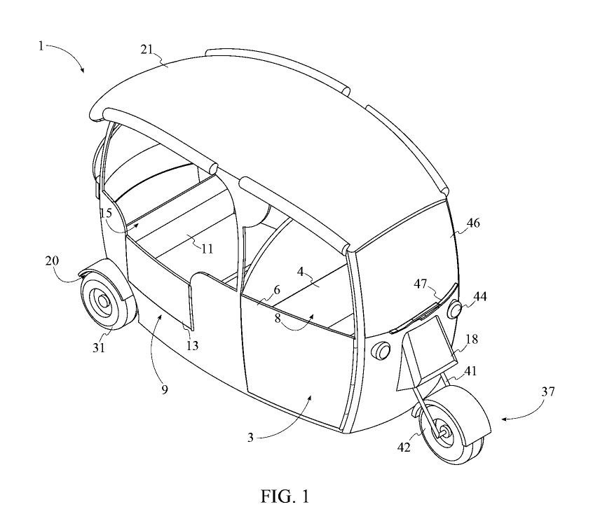

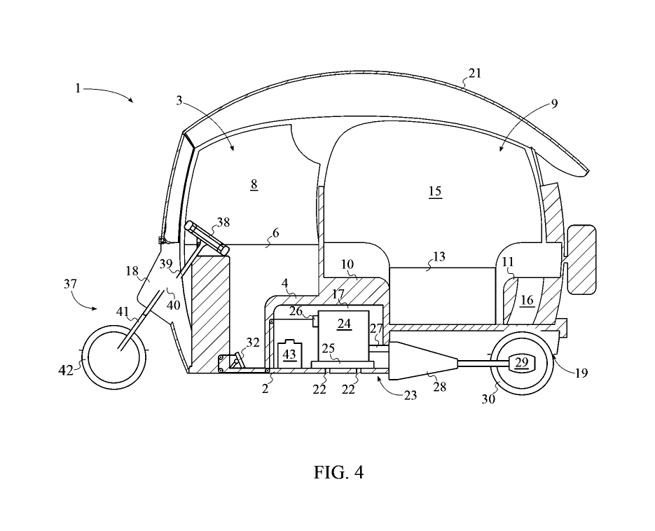

The present invention is a three-wheeled vehicle that is designed for use in sightseeing and tourism applications as well as for conventional transportation applications. The three-wheeled vehicle is shown in FIGS. 1-3. The present invention comprises a vehicle body 1, a power train 23, and a steering system 37. The power train 23 and the steering system 37 are depicted in FIG. 4. The vehicle body 1 encloses the driver and passengers of the present invention during use. The power train 23 allows the present invention to be self-propelled by creating mechanical motion as well as travel along a roadway. The steering system 37 is utilized to control the movement direction of the present invention during use.

The vehicle body 1 comprises a vehicle bed 2, a driver compartment 3, a passenger compartment 9, an engine compartment 17, and an arched roof 21. The vehicle bed 2 serves as the base of the vehicle body 1 onto which the driver compartment 3, the passenger compartment 9, and the engine compartment 17 are situated. The engine compartment 17 is positioned in between the driver compartment 3 and the passenger compartment 9. The engine compartment 17 partially traverses into the driver compartment 3 and the passenger compartment 9 and provides a base for driver and passenger seating. The driver compartment 3 encloses the driver of the present invention while the passenger compartment 9 encloses any passengers onboard the present invention. The engine compartment 17 separates the mechanical components of the present invention that are in motion from the driver and passengers of the present invention. The arched roof 21 is mounted onto the driver compartment 3 and the passenger compartment 9, opposite to the vehicle bed 2. This allows the arched roof 21 to provide cover from precipitation and overhead sunlight for the driver and passengers of the present invention. Additionally, the curving design of the arched roof 21 allows taller passengers to be seated comfortably.

Again with reference to FIGS. 1-4, the power train 23 comprises a left drive wheel 30 and a right drive wheel 31 that propel the present invention along a roadway. The steering system 37 comprises a front wheel 42 that is controlled by the driver in order to direct the movement of the present invention.

The left drive wheel 30 is positioned adjacent to the passenger compartment 9. Additionally, the left drive wheel 30 is rotatably mounted into the passenger compartment 9. Similarly, the right drive wheel 31 is positioned adjacent to the passenger compartment 9, opposite to the left drive wheel 30. The right drive wheel 31 is rotatably mounted into the passenger compartment 9 as well. The positioning of the left drive wheel 30 and the right drive wheel 31 on the passenger compartment 9 allows the present invention to be propelled along a roadway by the rotational motion of the left drive wheel 30 and right drive wheel 31. Additionally, the left drive wheel 30 and the right drive wheel 31 may rotate freely along a surface while the present invention is in motion. The front wheel 42 is positioned adjacent to the driver compartment 3, opposite to the passenger compartment 9. Similar to the left drive wheel 30 and the right drive wheel 31, the front wheel 42 is rotatably mounted to the driver compartment 3. The positioning of the front wheel 42 allows the driver of the present invention to control the direction of movement of the present invention while the present invention is in motion. Similar to the left drive wheel 30 and the right drive wheel 31, the front wheel 42 is able to rotate freely upon a surface while the present invention is in motion.

The driver compartment 3 comprises a driver seat 4 that serves as seating for the driver of the present invention. The passenger compartment 9 comprises a first bench 10, a second bench 11, and a luggage compartment 16. The driver seat 4 is positioned adjacent to the portion of the engine compartment 17 that partially traverses into the driver compartment 3. The driver seat 4 is opposite to the vehicle bed 2, relative to the engine compartment 17. The positioning of the driver seat 4 permits a driver, seated on the driver seat 4, to be completely within the driver compartment 3 while operating the present invention. The first bench 10 is positioned adjacent to the portion of the engine compartment 17 that partially traverses into the passenger compartment 9. The first bench 10 is opposite to the vehicle bed 2, relative to the engine compartment 17. The positioning of the first bench 10 permits passengers, seated on the first bench 10, to be completely within the passenger compartment 9. The driver seat 4 and the first bench 10 are oppositely oriented away from each other in order to provide a degree of separation between the driver and passengers. The second bench 11 is positioned adjacent to the first bench 10, opposite to the driver compartment 3. The second bench 11 provides additional seating for passengers within the passenger compartment 9. The first bench 10 and the second bench 11 are opposite oriented towards each other. This orientation of the first bench 10 and the second bench 11 allow passengers seated on the first bench 10 and the second bench 11 to face one another, facilitating conversation during the course of a sightseeing tour or journey. The luggage compartment 16 is integrated into the passenger compartment 9 adjacent to the second bench 11. The luggage compartment 16 provides a degree of storage capacity for passenger luggage and other personal belongings.

Referring to FIG. 4, the power train 23 further comprises an engine 24. The engine 24 is capable of converting energy to mechanical motion in order to propel the present invention. The present invention is not limited with respect to the specific type of engine 24 utilized to create motion and propel the present invention. The engine 24 is mounted to the vehicle bed 2 within the engine compartment 17 in order to separate the engine 24 from the driver and passengers of the present invention. The vehicle body 1 further comprises a plurality of ventilation holes 22. Due to the enormous amount of heat that is generated by an engine 24 under operation, the ventilation holes allow the heat to escape from the vehicle body 1. The plurality of ventilation holes 22 traverse through the vehicle bed 2 and into the engine compartment 17 in order to allow heat generated by the engine 24 to escape from the engine compartment 17 into the exterior environment. The engine 24 may be cooled by a radiator 25. The radiator 25 of the engine 24 is positioned adjacent to the plurality of ventilation holes 22. During engine 24 cooling, engine 24 coolant is cycled through the engine 24 and then through the radiator 25. The radiator 25 allows the heat to be dissipated into the atmosphere through the plurality of ventilation holes 22 positioned adjacent to the radiator 25.

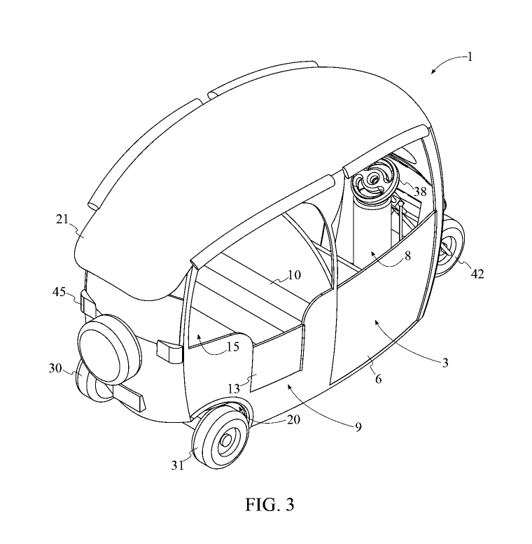

Again referring to FIG. 3, the driver compartment 3 further comprises a driver left door 5, a driver right door 6, a driver left window 7, and a driver right window 8. The driver left door 5 and the driver right door 6 are positioned opposite to each other to allow the driver to enter or exit the driver compartment 3 from both sides. The driver left door 5 and the driver right door 6 are hingedly mounted into the driver compartment 3 in order to allow the driver left door 5 and the driver right door 6 to be opened and closed to provide convenient access into and out of the driver compartment 3. The driver left window 7 and the driver right window 8 are positioned opposite to each other to provide vision to the driver in both directions. The driver left window 7 and the driver right window 8 open the driver compartment 3 to the exterior environment and provide unimpeded vision to the driver. The driver left door 5 is positioned adjacent to the driver left window 7 while the driver right door 6 is positioned adjacent to the driver right window 8. Because of the open-air design of the driver compartment 3, this allows the driver left door 5, the driver right door 6, the driver left window 7, and the driver right window 8 to be utilized as entrances and exits into and out of the driver compartment 3.

Similar to the driver compartment 3, the passenger compartment 9 further comprises a passenger left door 12, a passenger right door 13, a passenger left window 14 and a passenger right window 15. The passenger left door 12 and the passenger right door 13 are positioned opposite to each other as well in order to allow passengers to enter or exit the passenger compartment 9 from both sides. The passenger left door 12 and the passenger right door 13 are hingedly mounted into the passenger compartment 9, allowing the passenger left door 12 and the passenger right door 13 to be opened and closed as needed when entering or exiting the passenger compartment 9. The passenger left window 14 and the passenger right window 15 are positioned opposite to each other in order to provide unimpeded vision of both directions for passengers. The passenger left window 14 and the passenger right window 15 provide unimpeded vision of the exterior environment for passengers. This is particularly important for sightseeing tours where an unobstructed view of local landmarks and attractions is desired. The passenger left door 12 is positioned adjacent to the passenger left window 14 and the passenger right door 13 is positioned adjacent to the passenger right window 15. Similar to the driver compartment 3, the passenger left door 12, the passenger right door 13, the passenger left window 14, and the passenger right window 15 may be utilized as entrances and exits into and out of the passenger compartment 9.

Again referring to FIG. 4, the present invention further comprises an acceleration pedal 32. The acceleration pedal 32 is positioned within the driver compartment 3, adjacent to a steering wheel 38 of a steering system 37. This provides convenient access for the driver to the acceleration pedal 32 when seated on the driver seat 4. The power train 23 further comprises a transmission 28 and a differential 29. The transmission 28 is capable of providing conversions of outputted speed and torque that is provided by the engine 24 during operation to the left drive wheel 30 and the right drive wheel 31. The transmission 28 features multiple gears with the driver able to switch between gear ratios either manually or automatically. The engine 24 comprises a throttle 26 that is operatively connected to the acceleration pedal 32. The acceleration pedal 32 is used by the driver to control the throttle 26 in order to regulate the supply of fuel and air to the engine 24 and thus, the movement speed of the vehicle. The engine 24 further comprises an output shaft 27 that is torsionally connected into the differential 29 through the transmission 28. The output shaft 27 transfers rotational motion provided by the engine 24 to the transmission 28 and the differential 29. The differential 29 is in turn torsionally connected into the left drive wheel 30 and the right drive wheel 31. The differential 29 allows the left drive wheel 30 and the right drive wheel 31 to rotate at different speeds. This is particularly beneficial in situations such as when the present invention is turning a corner as the differential 29 provides improved traction for the left drive wheel 30 and the right drive wheel 31 as well as improved handling of the present invention.

Again with reference to FIG. 4, the transmission 28 and the differential 29 are positioned adjacent to the passenger compartment 9 with the transmission 28 mounted onto the vehicle bed 2 and the differential 29 mounted onto the vehicle bed 2 as well. This places the transmission 28 and the differential 29 in close proximity with the engine 24 as the engine 24 is mounted to the vehicle bed 2 as well within the engine compartment 17. The arrangement of the transmission 28, the differential 29, and the engine 24 provides compactness to the component assembly and increased space for passengers within the present invention.

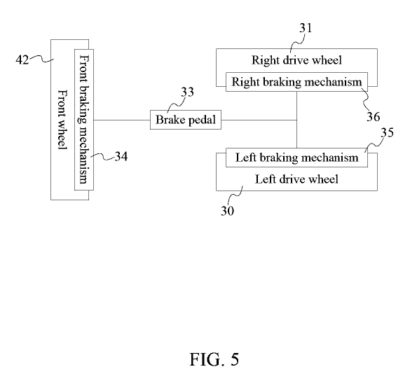

Referring to FIG. 5, the present invention further comprises a brake pedal 33, a front braking mechanism 34, a left braking mechanism 35, and a right braking mechanism 36. The brake pedal 33 is positioned adjacent to the steering wheel 38 for convenient access by the driver. The front braking mechanism 34 is operatively integrated into the front wheel 42 in order to reduce the rotational speed of the front wheel 42. Similarly, the left braking mechanism 35 is operatively integrated into the left drive wheel 30 to reduce rotational speed of the left drive wheel 30. Finally, the right braking mechanism 36 is operatively integrated into the right drive wheel 31, allowing the right braking mechanism 36 to reduce rotational speed of the right drive wheel 31. The front braking mechanism 34, the left braking mechanism 35, and the right braking mechanism 36 allow the driver to reduce the movement speed of the present invention and to bring the present invention to a complete stop. The brake pedal 33 is operatively coupled to the front braking mechanism 34, the left braking mechanism 35, and the right braking mechanism 36. More specifically, the brake pedal 33 is used by the driver to actuate the front braking mechanism 34, the left braking mechanism 35, and the right braking mechanism 36 when the driver wishes to reduce the movement speed of the present invention or to bring the present invention to a complete stop.

The steering system 37 allows the driver to maintain control over the movement direction of the present invention. The steering system 37 comprises a steering wheel 38, a steering column 39, an offset mechanism 40, a wheel fork 41, and a front wheel 42. The steering wheel 38 serves as the point of input for the driver when controlling the movement direction of the present invention. As such, the steering wheel 38 is rotatably mounted within the driver compartment 3, opposite to the driver seat 4, in order to provide the driver with convenient access to the steering wheel 38. The steering column 39 is torsionally connected to the steering wheel 38. The steering column 39 is additionally torsionally connected to the wheel fork 41 through the offset mechanism 40. As such, the torque provided by the driver's input through the steering wheel 38 may be transferred to the offset mechanism 40 and the wheel fork 41 via the steering column 39. The wheel fork 41 supports the front wheel 42 when the front wheel 42 is in contact with a surface such as a roadway. The front wheel 42 is rotatably connected in between the wheel fork 41 in order to hold the front wheel 42 in place while allowing the front wheel 42 to rotate freely.

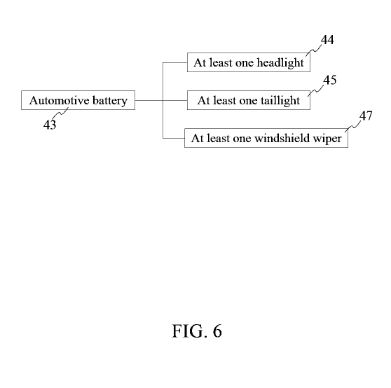

The present invention further comprises an automotive battery 43, at least one headlight 44, and at least one taillight 45. As shown in FIG. 6, the automotive battery 43 is electrically connected to the at least one headlight 44 and to the at least one taillight 45. In addition to providing electrical power to the at least one headlight 44 and to the at least one taillight 45, the automotive battery 43 additionally provides electrical power to additional electronic components of the present invention such as, but not limited to, interior lighting devices and charging ports. The automotive battery 43 is mounted within the engine compartment 17 for consolidation of the automotive battery 43 and components of the power train 23 such as the engine 24. The at least one headlight 44 is externally mounted to the driver compartment 3, opposite to the passenger compartment 9. This positioning allows the at least one headlight 44 to provide illumination to the environment in front of the present invention. The at least one taillight 45 is externally mounted to the passenger compartment 9, opposite to the driver compartment 3. The at least one taillight 45 is able to provide illumination to the environment behind the present invention. Additionally, the at least one headlight 44 and the at least one taillight 45 increase the visibility of the present invention in poorly lit conditions.

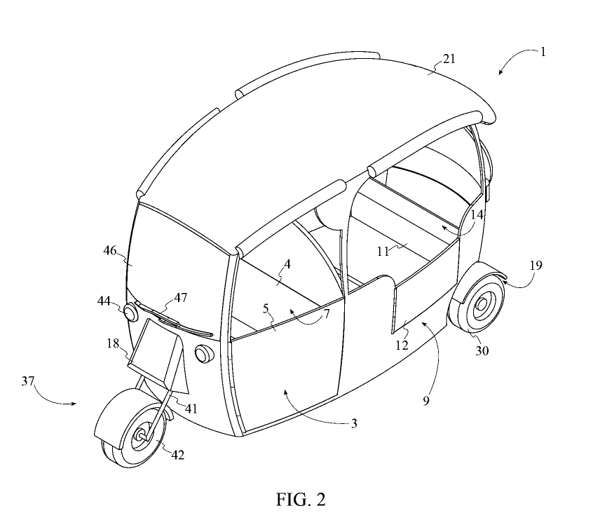

The present invention further comprises a windshield 46 and at least one windshield wiper 47. Again referring to FIG. 1 and FIG. 2, the windshield 46 is mounted to the driver compartment 3 in between the driver left window 7 and the driver right window 8. The windshield 46 provides an unobstructed view of the area in front of the present invention for the driver. Additionally, the windshield 46 serves as a barrier against wind and particles from the exterior environment that may potentially impact the driver's vision and/or ability to drive. The at least one windshield wiper 47 is pressed against the windshield 46 and is pivotally and externally mounted to the driver compartment 3. This allows the at least one windshield wiper 47 to sweep across the windshield 46 in order to remove precipitation and particles that may accumulate on the windshield 46 and obstruct the driver's vision. The at least one windshield wiper 47 is powered by the automotive battery 43 and as such is electrically connected to the automotive battery 43.

The present invention further comprises a front wheel shield 18, a left rear wheel well 19, and a right rear wheel well 20. The front wheel shield 18 provides protection for the steering column 39, the offset mechanism 40, and the wheel fork 41. As such, the front wheel shield 18 is externally mounted to the driver compartment 3 opposite to the engine compartment 17. The front wheel shield 18 is additionally positioned adjacent to the front wheel 42. Similarly, the left rear wheel well 19 and the right rear wheel well 20 provide protection for the left drive wheel 30 and the right drive wheel 31. The left rear wheel well 19 is integrated into the passenger compartment 9 and the left drive wheel 30 is positioned into the left rear wheel well 19. Similarly, the right rear wheel well 20 is integrated into the passenger compartment 9, opposite to the left rear wheel well 19. The right drive wheel 31 is positioned into the right rear wheel well 20.

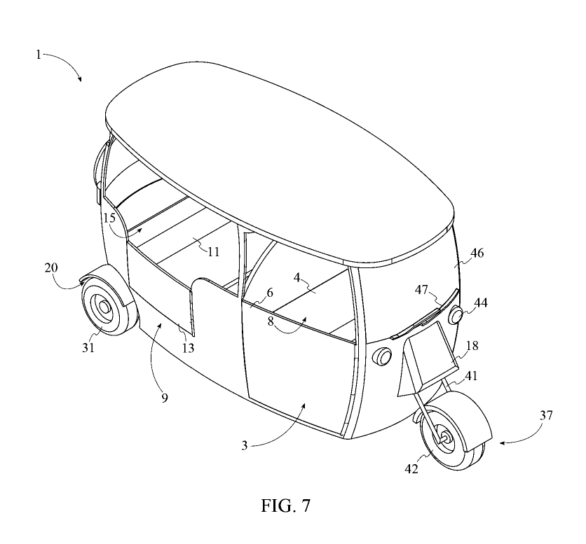

The three-wheeled vehicle of the present invention may comprise a variety of additional features. The present invention may comprise an audio system for providing audio entertainment to the driver and passengers of the present invention. Charge outlets powered by the automotive battery 43 may be present for allowing the driver and passengers to charge portable electronic devices. The present invention may include a spare tire in the event that the front wheel 42, the left drive wheel 30, or the right drive wheel 31 is compromised due to tire failure. Seatbelts may be present for the driver seat 4, the first bench 10, and the second bench 11 to provide additional safety for the driver and passengers of the present invention. The present invention may further comprise deployable window covers in order to provide additional cover for the driver and passengers beyond that provided by the arched roof 21. The deployable window covers may be positioned adjacent to the driver left window 7, the driver right window 8, the passenger left window 14, and the passenger right window 15. This allows the deployable window covers to be utilized to provide cover for the driver and passengers against the elements, such as precipitation. Alternative embodiments of the present invention may forgo the arched roof 21 in lieu of a flat roof as shown in FIG. 7.

Although the invention has been explained in relation to its preferred embodiment, it is to be understood that many other possible modifications and variations can be made without departing from the spirit and scope of the invention as hereinafter claimed.

What is claimed is:

1. A three-wheeled vehicle comprises:
a vehicle body;
a power train;
a steering system;
the vehicle body comprises a vehicle bed, a driver compartment, a passenger compartment, an engine compartment, and an arched roof;
the power train comprises an engine, a left drive wheel, and a right drive wheel;
the steering system comprises a front wheel;
the driver compartment, the passenger compartment, and the engine compartment being situated on the vehicle bed;
the engine compartment being positioned in between the driver compartment and the passenger compartment;
the engine being mounted to the vehicle bed within the engine compartment;
the arched roof being mounted onto the driver compartment and the passenger compartment, opposite to the vehicle bed;
the left drive wheel being rotatably and adjacently mounted into the passenger compartment;
the right drive wheel being rotatably mounted into and adjacently mounted into the passenger compartment, opposite to the left drive wheel; and
the front wheel being rotatably and adjacently mounted to the driver compartment, opposite to the passenger compartment.

2. The three-wheeled vehicle as claimed in claim 1 further comprises:
the driver compartment comprises a driver seat;
the passenger compartment comprises a first bench, a second bench, and a luggage compartment;
the driver seat being positioned adjacent to the engine compartment, opposite to the vehicle bed;
the first bench being positioned adjacent to the engine compartment, opposite to the vehicle bed;
the driver seat and the first bench being oppositely oriented away from each other;
the second bench being positioned adjacent to the first bench, opposite to the driver compartment;
the first bench and the second bench being oppositely oriented towards each other; and
the luggage compartment being integrated into the passenger compartment adjacent to the second bench.

3. The three-wheeled vehicle as claimed in claim 1 further comprises:
the vehicle body further comprises a plurality of ventilation holes;
the plurality of ventilation holes traversing through the vehicle bed and into the engine compartment; and
a radiator of the engine being positioned adjacent to the plurality of ventilation holes.

4. The three-wheeled vehicle as claimed in claim 1 further comprises:
the driver compartment further comprises a driver left door, a driver right door, a driver left window and a driver right window;
the driver left door and the driver right door being positioned opposite to each other;
the driver left door and the driver right door being hingedly mounted into the driver compartment;
the driver left window and the driver right window being positioned opposite to each other;
the driver left door being positioned adjacent to the driver left window; and
the driver right door being positioned adjacent to the driver right window.

5. The three-wheeled vehicle as claimed in claim 1 further comprises:
the passenger compartment further comprises a passenger left door, a passenger right door, a passenger left window and a passenger right window;
the passenger left door and the passenger right door being positioned opposite to each other;
the passenger left door and the passenger right door being hingedly mounted into the passenger compartment;
the passenger left window and the passenger right window being positioned opposite to each other;
the passenger left door being positioned adjacent to the passenger left window; and
the passenger right door being positioned adjacent to the passenger right window.

6. The three-wheeled vehicle as claimed in claim 1 further comprises:
an acceleration pedal;
the power train further comprises a transmission and a differential;
the acceleration pedal being positioned within the driver compartment, adjacent to a steering wheel of a steering system;
a throttle of the engine being operatively connected to the acceleration pedal, wherein the acceleration pedal is used to control the throttle;
an output shaft of the engine being torsionally connected into the differential through the transmission; and
the differential being torsionally connected into the left drive wheel and the right drive wheel.

7. The three-wheeled vehicle as claimed in claim 6 further comprises:
the transmission and the differential being positioned adjacent to the passenger compartment;
the transmission being mounted into the vehicle bed; and
the differential being mounted onto the vehicle bed, opposite to the differential.

8. The three-wheeled vehicle as claimed in claim 1 further comprises:
a brake pedal;
a front braking mechanism;
a left braking mechanism;
a right braking mechanism;
the brake pedal being positioned adjacent to the steering wheel;
the front braking mechanism being operatively integrated into the front wheel;
the left braking mechanism being operatively integrated into the left drive wheel;
the right braking mechanism being operatively integrated into the right drive wheel; and
the brake pedal being operatively coupled to the front braking mechanism, the left braking mechanism, and the right braking mechanism, wherein the brake pedal is used to actuate the front braking mechanism, the left braking mechanism, and the right braking mechanism.

9. The three-wheeled vehicle as claimed in claim 1 further comprises:
the steering system further comprises a steering column, an offset mechanism, a wheel fork, and a front wheel;
the steering wheel being rotatably mounted within the driver compartment, opposite to the driver seat;
the steering column being torsionally connected to the steering wheel;
the steering column being torsionally connected to the wheel fork through the offset mechanism; and
the front wheel being rotatably connected in between the wheel fork.

10. The three-wheeled vehicle as claimed in claim 1 further comprises:
an automotive battery;
at least one headlight;
at least one taillight;
the automotive battery being electrically connected to the at least one headlight and to the at least one taillight;
the automotive battery being mounted within the engine compartment;
the at least one headlight being externally mounted to the driver compartment, opposite to the passenger compartment; and
the at least one taillight being externally mounted to the passenger compartment, opposite to the driver compartment.

11. The three-wheeled vehicle as claimed in claim 1 further comprises:
a windshield;
at least one windshield wiper;
the windshield being mounted to the driver compartment in between a driver left window of the driver compartment and to a driver right window of the driver compartment;
the at least one windshield wiper being pressed against the windshield;
the at least one windshield wiper being pivotally and externally mounted to the driver compartment; and
the at least one windshield wiper being electrically connected to an automotive battery.

12. The three-wheeled vehicle as claimed in claim 1 further comprises:
the vehicle body further comprises a front wheel shield, a left rear wheel well, and a right rear wheel well;
the front wheel shield being externally mounted to the driver compartment opposite to the engine compartment;
the front wheel shield being positioned adjacent to the front wheel;
the left rear wheel well being integrated into the passenger compartment;
the left drive wheel being positioned into the left rear wheel well;
the right rear wheel well being integrated into the passenger compartment, opposite to the left rear wheel well; and
the right drive wheel being positioned into the right rear wheel well.

13. A three-wheeled vehicle comprises:
a vehicle body;
a power train;
a steering system;
an acceleration pedal;
a brake pedal;
a front braking mechanism;
a left braking mechanism;
a right braking mechanism;
an automotive battery;
at least one headlight;
at least one taillight;
a windshield;
at least one windshield wiper;
the vehicle body comprises a vehicle bed, a driver compartment, a passenger compartment, an engine compartment, and an arched roof;
the power train comprises an engine, a left drive wheel, a right drive wheel, a transmission, and a differential;
the steering system comprises a front wheel;
the driver compartment, the passenger compartment, and the engine compartment being situated on the vehicle bed;
the engine compartment being positioned in between the driver compartment and the passenger compartment;
the engine being mounted to the vehicle bed within the engine compartment;
the arched roof being mounted onto the driver compartment and the passenger compartment, opposite to the vehicle bed;
the left drive wheel being rotatably and adjacently mounted into the passenger compartment;
the right drive wheel being rotatably mounted into and adjacently mounted into the passenger compartment, opposite to the left drive wheel;
the front wheel being rotatably and adjacently mounted to the driver compartment, opposite to the passenger compartment;
the acceleration pedal being positioned within the driver compartment, adjacent to a steering wheel of a steering system;
a throttle of the engine being operatively connected to the acceleration pedal, wherein the acceleration pedal is used to control the throttle;
an output shaft of the engine being torsionally connected into the differential through the transmission;
the differential being torsionally connected into the left drive wheel and the right drive wheel;
the brake pedal being positioned adjacent to the steering wheel;
the front braking mechanism being operatively integrated into the front wheel;
the left braking mechanism being operatively integrated into the left drive wheel;
the right braking mechanism being operatively integrated into the right drive wheel;
the brake pedal being operatively coupled to the front braking mechanism, the left braking mechanism, and the right braking mechanism, wherein the brake pedal is used to actuate the front braking mechanism, the left braking mechanism, and the right braking mechanism;
the transmission and the differential being positioned adjacent to the passenger compartment;
the transmission being mounted into the vehicle bed;
the differential being mounted onto the vehicle bed, opposite to the differential;
the automotive battery being electrically connected to the at least one headlight and to the at least one taillight;
the automotive battery being mounted within the engine compartment;
the at least one headlight being externally mounted to the driver compartment, opposite to the passenger compartment;
the at least one taillight being externally mounted to the passenger compartment, opposite to the driver compartment;
the windshield being mounted to the driver compartment in between a driver left window of the driver compartment and to a driver right window of the driver compartment;
the at least one windshield wiper being pressed against the windshield;
the at least one windshield wiper being pivotally and externally mounted to the driver compartment; and
the at least one windshield wiper being electrically connected to an automotive battery.

14. The three-wheeled vehicle as claimed in claim 13 further comprises:
the driver compartment comprises a driver seat;
the passenger compartment comprises a first bench, a second bench, and a luggage compartment;
the driver seat being positioned adjacent to the engine compartment, opposite to the vehicle bed;
the first bench being positioned adjacent to the engine compartment, opposite to the vehicle bed;
the driver seat and the first bench being oppositely oriented away from each other;
the second bench being positioned adjacent to the first bench, opposite to the driver compartment;
the first bench and the second bench being oppositely oriented towards each other; and
the luggage compartment being integrated into the passenger compartment adjacent to the second bench.

15. The three-wheeled vehicle as claimed in claim 13 further comprises:
the vehicle body further comprises a plurality of ventilation holes;
the plurality of ventilation holes traversing through the vehicle bed and into the engine compartment; and
a radiator of the engine being positioned adjacent to the plurality of ventilation holes.

16. The three-wheeled vehicle as claimed in claim 13 further comprises:
the driver compartment further comprises a driver left door, a driver right door, a driver left window and a driver right window;
the driver left door and the driver right door being positioned opposite to each other;
the driver left door and the driver right door being hingedly mounted into the driver compartment;
the driver left window and the driver right window being positioned opposite to each other;
the driver left door being positioned adjacent to the driver left window; and
the driver right door being positioned adjacent to the driver right window.

17. The three-wheeled vehicle as claimed in claim 13 further comprises:
the passenger compartment further comprises a passenger left door, a passenger right door, a passenger left window and a passenger right window;
the passenger left door and the passenger right door being positioned opposite to each other;
the passenger left door and the passenger right door being hingedly mounted into the passenger compartment;
the passenger left window and the passenger right window being positioned opposite to each other;
the passenger left door being positioned adjacent to the passenger left window; and
the passenger right door being positioned adjacent to the passenger right window.

18. The three-wheeled vehicle as claimed in claim 13 further comprises:
the steering system further comprises a steering column, an offset mechanism, a wheel fork, and a front wheel;
the steering wheel being rotatably mounted within the driver compartment, opposite to the driver seat;
the steering column being torsionally connected to the steering wheel;
the steering column being torsionally connected to the wheel fork through the offset mechanism; and
the front wheel being rotatably connected in between the wheel fork.

19. The three-wheeled vehicle as claimed in claim 13 further comprises:
the vehicle body further comprises a front wheel shield, a left rear wheel well, and a right rear wheel well;
the front wheel shield being externally mounted to the driver compartment opposite to the engine compartment;
the front wheel shield being positioned adjacent to the front wheel;
the left rear wheel well being integrated into the passenger compartment;
the left drive wheel being positioned into the left rear wheel well;
the right rear wheel well being integrated into the passenger compartment, opposite to the left rear wheel well; and
the right drive wheel being positioned into the right rear wheel well.
